(19) United States
(12) Patent Application Publication
(10) Pub. No.: US 2020/0113294 A1
(43) Pub. Date: Apr. 16, 2020

(54) Animal Articles

(71) Applicant: Robert K. Ilowite, Hillsborough, NJ (US)

(72) Inventor: Robert K. Ilowite, Hillsborough, NJ (US)

(21) Appl. No.: 16/594,529

(22) Filed: Oct. 7, 2019

Related U.S. Application Data
(60) Provisional application No. 62/743,809, filed on Oct. 10, 2018.

(51) Int. Cl. A44C 3/00; G09F 3/02

(52) U.S. Cl. CPC A44C 3/004; G09F 2003/0254; G09F 3/02

(57) ABSTRACT

Provided are animal articles, such as medallions and toys, that present beloved animals that have tails by positioning the tail upwards in a friendly and inviting way. Medallions are articles that can be hung from or attached to other items. Medallions include but are not limited to: tags (e.g., luggage tags), key chains, and jewelry. The articles may be two-sided in that a front view of the animal is provided on a first surface of the article and a back view of the animal is provided on a second/back surface of the article.

### CROSS-REFERENCE TO RELATED APPLICATION

This application claims priority under 35 U.S.C. § 119(e) to U.S. Provisional Application No. 62/743,809, filed Oct. 10, 2018, the disclosure of which is incorporated herein by reference in its entirety.

### TECHNICAL FIELD

The present disclosure relates to articles that depict an animal with a tail, which is presented by positioning the tail upwards.

### BACKGROUND

Many pet owners and animal lovers collect items such as toys, gadgets, and/or jewelry that depict pets and animals. Such items can bring satisfaction and enjoyment as a reminder of the animals they love and appreciate. Making such items durable and long-lasting while being designed for visual appeal is an ongoing challenge.

### SUMMARY

Provided herein are articles that depict an animal with a tail. The articles herein present beloved animals that have tails by positioning the tail upwards in a friendly and inviting way. Through the tail is a hole, which may be for receipt of a fastener for display and/or general use of the article. The tail itself provides a sturdy handle for holding. Placement of the hole in the tail allows for an unimpeded view and enjoyment of the animal body. For example, the hole does not interfere with the appearance of the animal face.

The articles herein are readily portable, e.g., they may be hand-held. Articles include but are not limited to toys and medallions. Medallions are articles that can be hung from or attached to other items. Medallions include but are not limited to: tags (e.g., luggage tags), key chains, and jewelry. The articles may be of any desired depth dimension. The articles may be two-sided in that a front view of the animal is provided on a first surface of the article and a back view of the animal is provided on a second/back surface of the article.

### BRIEF DESCRIPTION OF THE DRAWINGS

The figures depict several embodiments described below.

FIG. 1 is a front view of an animal article according to an embodiment;

FIG. 2 is a right/left side view of the animal article of FIG. 1;

FIG. 3 is a back view of the animal article of FIG. 1;

FIG. 4 is a front view of an animal article according to an embodiment;

FIG. 5 is a right/left side view of the animal article of FIG. 4;

FIG. 6 is a back view of the animal article of FIG. 4;

FIG. 7 is a front view of an animal article according to an embodiment;

FIG. 8 is a back view of the animal article of FIG. 7;

FIG. 9 is a front view of an animal article according to an embodiment;

FIG. 10 is a back view of the animal article of FIG. 9;

FIG. 11 is a front view of an animal article according to an embodiment;

FIG. 12 is a back view of the animal article of FIG. 11;

FIG. 13 is a front view of an animal article according to an embodiment;

FIG. 14 is a back view of the animal article of FIG. 13;

FIG. 15 is a front view of an animal article according to an embodiment;

FIG. 16 is a back view of the animal article of FIG. 15;

FIG. 17 is a front view of an animal article according to an embodiment;

FIG. 18 is a back view of the animal article of FIG. 17;

FIG. 19 is a tail comprising one or more tactile features; and

FIG. 20 is an article including an area for receiving personalized information.

### DETAILED DESCRIPTION

Articles herein depict animals that have tails, where the tail is presented in an appealing way by positioning the tail upwards. The tail can serve as a handhold. The tail may include a hole for receipt of a fastener so that the article may be affixed to other items as, for example, jewelry or luggage tags or key chains. The items may be two-sided in that a front view of the animal is provided on a first surface of the article and a back view of the animal is provided on a second/back surface of the article. Placement of the tail in an upward position provides a handhold for an unimpeded view of the animal body including the face. Placement of the hole in the tail also allows for an unimpeded view of the animal body including the face. Selection of the tail shape and configuration provides ways to enhance use and enjoyment. In one or more embodiments, the animal body and tail are in the same plane, which facilitates manufacture and handling. In one or more embodiments, the tail is designed to provide sensory enhancements, including but not limited to tactile and visual features. Tactile features may include textures such as fur, bumps, ridges, and the like. Visual features may include options to personalize the tail by including a pet's or owner's name. Articles herein may be manufactured without decoration for further decoration by consumers. For example, the tail and one or more other features of the article may be amenable to further personalization with colors and affixed decorations.

Human interactions with animals, such as a pet, can have many benefits. Anxiety and depression have become a modern plague in human society, with an estimated 16 million adults in the United States experiencing at least one major depressive episode a year. For young people, rates of depression can be even higher. Research has shown that animals, particularly domestic cats and domestic dogs, offer health and happiness benefits for humans. A human association with animals, such as a pet, has been linked to a reduction in cardiovascular disease risk factors, such as lower blood pressure, lower cholesterol levels, and lower level of obesity. Other studies have found that associations with animals cause humans to become more empathetic and provides an increase in self-esteem. Additionally, association with animals may lead to an increase in social connections, mood enhancement, and order/routine in one's life. Thus, article of one or more embodiments disclosed herein, with the animal tail presented in an upwards position allows the viewer to enjoy the animal body and face, which may, in turn, lead to one or more of the above mentioned health and happiness beneficial effects. Addition of tactile features, to the tail in particular, may have therapeutic and anxiety-reducing benefits.

Animals that have tails, where the tail is presented in an appealing way by positioning the tail upwards may include, but are not limited to, felidae, canidae, equidae, suidae, bovinae, leporidae, mephitidae, mustelidae, procyonidae, rodentia, sciuridae, and the like. As used herein, the term “felidae” includes, but is not limited to, tiger, lion, jaguar, leopard, snow leopard, clouded leopard, Sunda clouded leopard, lynx, cougar, jaguarondi, cheetah, ocelot, serval, European wildcat, African wildcat, Chinese mountain cat, jungle cat, sand cat, leopard cat, fishing cat, domestic cat, and the like. As used herein, the term “canidae” includes, but is not limited to, gray wolf, red wolf, Eastern wolf, coyote, coywolf, maned wolf, Arctic fox, red fox, gray fox, island fox, swift fox, kit fox, Bengal fox, Tibetan sand fox, domesticated fox, Golden jackal, side-striped jackal, black-backed jackal, dingo, African wild dog, short-eared dog, domestic dogs, and the like. As used herein the term “equidae” includes, but is not limited to, horses, donkeys, zebras, and the like. As used herein, the term “sudae” includes, but is not limited to bearded pig, warty pig, domestic pig, giant forest hog, bushpig, red river hog, pygmy hog, common warthog, desert warthog, wild boar, and the like. As used herein, the term “bovinae” includes, but is not limited to, cattle, cow, bison, buffalo, water buffalo, antelope, yak, and the like. As used herein, the term “leporidae” includes, but is not limited to rabbit, cottontail, hare, jackrabbit, and the like. As used herein, the term “mephitidae” includes, but is not limited to skunk and badger, for example hooded skunk, striped skunk, hog-nosed skunk, striped hog-nosed skunk, spotter skunk, stink badger, and the like. As used herein, the term “mustelidae” includes, but is not limited to otter, polecat, ferret, weasel, wolverine, ferret-badger, and the like. As used herein, the term “procyonidae” includes, but is not limited to, raccoon, coati, kinkajous, olingo, olinguitos, ringtail, cacomistle, and the like. As used herein, the term “rodentia” includes, but is not limited to, mouse, rat, squirrel, prairie dog, chipmunk, porcupine, beaver, guinea pig, hamster, gerbil, capybara, and the like. As used herein, the term “scuiridae” includes, but is not limited to, tree squirrel, ground squirrel, chipmunk, marmot, woodchuck, flying squirrel, prairie dog, and the like.

The figures of animal articles herein depict an exemplary cat and an exemplary dog. It is understood that the scope of the claims is not limited to the cat and dog designs of the figures. Any animal having a tail may be depicted. The scopes of the claims herein allow for variations in body and tail shapes, and ornamentation. The animals may be presented, for example, in cartoon-style with fanciful colors and/or with realistic features and colors.

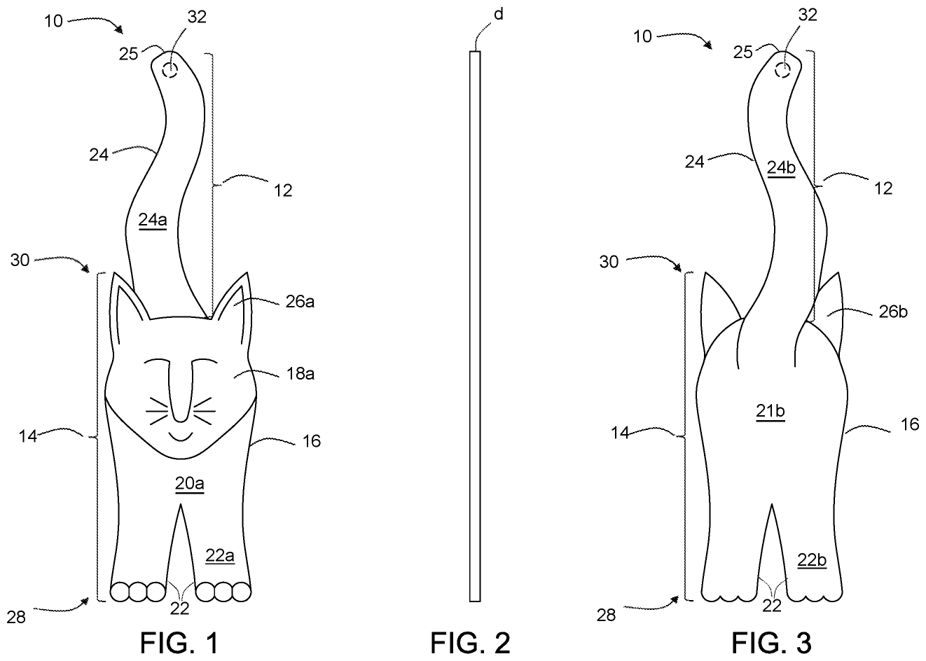

Turning to the figures, FIG. 1 is a front view of an animal article 10; FIG. 2 is a right/left side view of the animal article; and FIG. 3 is a back view of the animal article. The article of FIGS. 1-3 is in the form of a cat medallion. The animal article 10 comprises a main section 14, and a tab section 12 that extends from the main section 14. The tab section 12 of FIGS. 1 and 3 comprises a portion of the cat tail 24. The main section 14 of FIGS. 1 and 3 comprises a portion of the cat body 16. In FIG. 1, front views of the face 18a, torso 20a, legs 22a, tail 24a, and ears 26a are depicted. In FIG. 3, back views of the back side 21b, legs 22b, tail 24b, and ears 26b are depicted. The legs 22 are at a first end 28 of the main section and the tail 24 extends from a second end 30 of the main section, which is opposite from the first end 28 at the top of the animal head. In the embodiment of FIGS. 1-3, the main section is coextensive with the portion of the cat body 16 in that the edges of the article follow the edges of the depiction of the cat body. In the embodiment of FIGS. 1-3, the tab section is coextensive with the portion of the cat tail 24 to a tip 25 of the tail in that the edges of the article follow the edges of the depiction of the cat tail to its tip. FIG. 2 shows the right/left view of the medallion having a depth “d”. In FIG. 2, it is shown that the portion of the body and the portion of the tail are in the same plane in this embodiment. The tab section 12 optionally comprises a hole 32 from the front surface to the back surface, which may be for receipt of a fastener for display and/or general use of the article.

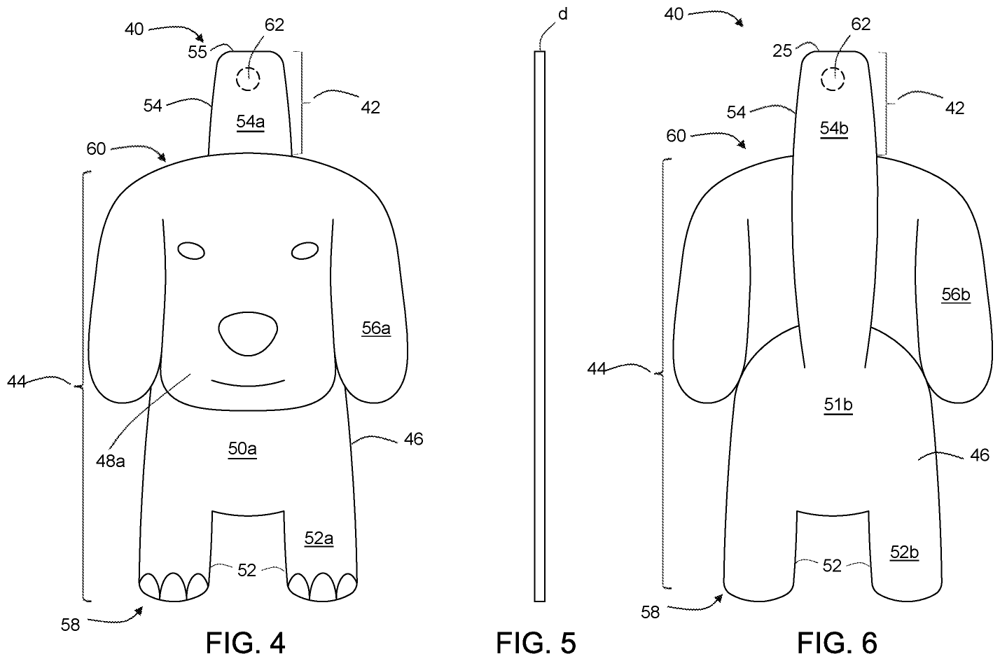

FIG. 4 is a front view of an animal article 40; FIG. 5 is a right/left side view of the animal article; and FIG. 6 is a back view of the animal article. The article of FIGS. 4-6 is in the form of a dog medallion. The animal article 40 comprises a main section 44, and a tab section 42 that extends from the main section 44. The tab section 42 of FIGS. 4 and 6 comprise a portion of the dog tail 54. The main section 44 of FIGS. 4 and 6 comprises a portion of the cat body 46. In FIG. 4, front views of the face 48a, torso 50a, legs 52a, tail 54a, and ears 56a are depicted. In FIG. 5, back views of the back side 51b, legs 52b, tail 54b, and ears 56b are depicted. The legs 52 are at a first end 58 of the main section and the tail 54 extends from a second end 60 of the main section, which is opposite from the first end 58 at the top of the animal head. In the embodiment of FIGS. 4-6, the main section 44 is coextensive with the portion of the dog body 46 in that the edges of the article follow the edges of the depiction of the dog body. In the embodiment of FIGS. 4-6, the tab section is coextensive with the portion of the dog tail 54 to a tip 55 of the tail in that the edges of the article follow the edges of the depiction of the dog tail to its tip. FIG. 5 shows the right/left view of the medallion having a depth “d”. In FIG. 5, it is shown that the portion of the body and the portion of the tail are in the same plane in this embodiment. The tab section 42 optionally comprises a hole 62 from the front surface to the back surface, which may be for receipt of a fastener for display and/or general use of the article.

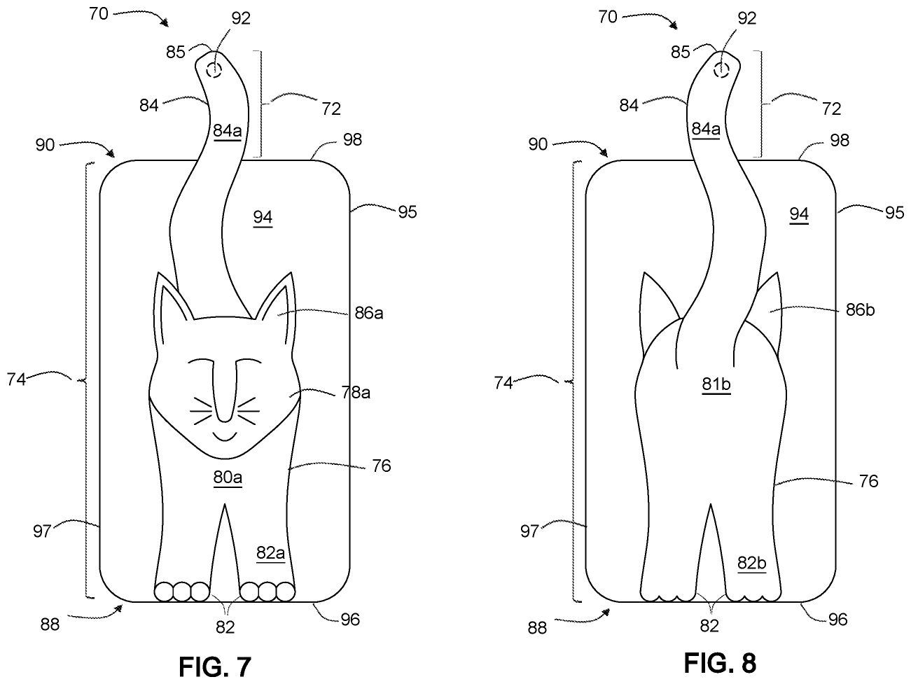

FIG. 7 is a front view of an animal article 70; and FIG. 8 is a back view of the animal article. The article of FIGS. 7-8 is in the form of a cat medallion. The animal article 70 comprises a main section 74, and a tab section 72 that extends from the main section 74. The tab section 72 of FIGS. 7-8 comprises a portion of the cat tail 54 to a tip 85 of the tail. The main section 74 of FIGS. 4 and 6 comprises a portion of the cat body 76 and a portion of the cat tail 84. In FIG. 7, front views of the face 78a, torso 80a, legs 82a, tail 84a, and ears 86a are depicted. In FIG. 8, back views of the back side 81b, legs 82b, tail 84b, and ears 86b are depicted. The legs 82 are at a first end 88 of the main section and a portion of the tail 84 extends from a second end 90 of the main section, which is opposite from the first end 88. In the embodiment of FIGS. 7-8, the main section 74 further comprises a background 94 around the cat body 76 in that the edges 95, 96, 97, and 98 of the main section 74 of the article frame the depiction of the cat body and portion of the tail. The overall shape of the main section may be any shape suitable for the application including but not limited to rectangular, square, circular, and oval. The background 94 may have any design including but not limited to solid colors and/or landscape or setting appropriate to the animal. In the embodiment of FIGS. 7-8, the tab section 72 is coextensive with the portion of the cat tail 84 to a tip 85 of the tail in that the edges of the article follow the edges of the depiction of the portion of the cat tail to its tip. Depth of the animal article may be analogous to that of FIGS. 2 and 5, or the depth may be varied to suit a particular application. The tab section 72 optionally comprises a hole 92 from the front surface to the back surface, which may be for receipt of a fastener for display and/or general use of the article.

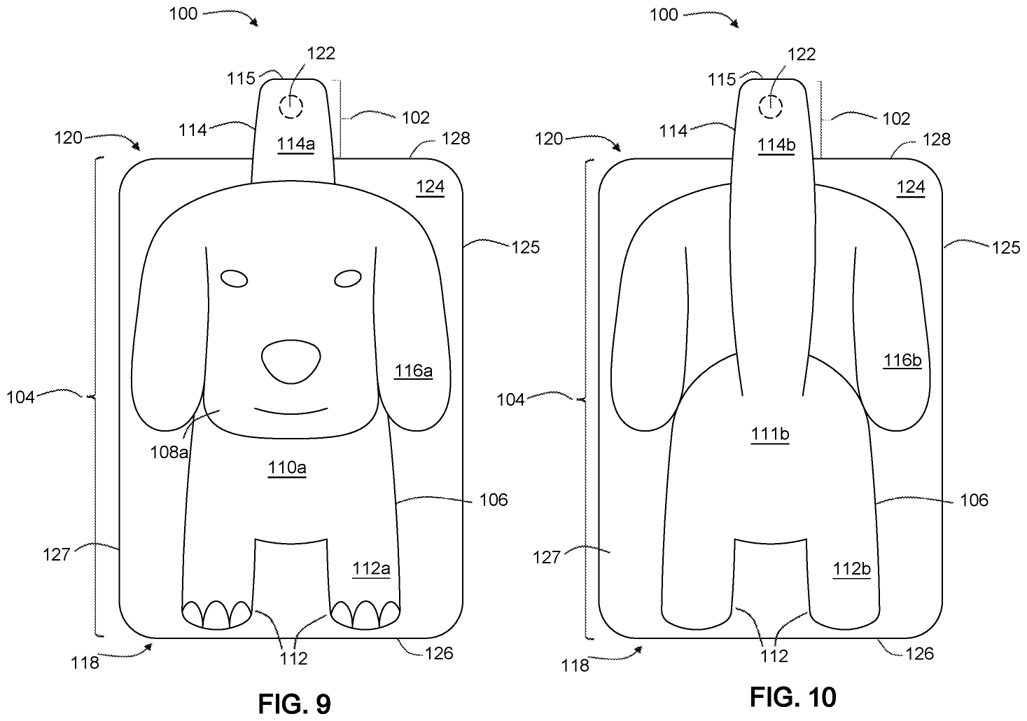

FIG. 9 is a front view of an animal article 100; and FIG. 10 is a back view of the animal article. The article of FIGS. 9-10 is in the form of a dog medallion. The animal article 100 comprises a main section 104, and a tab section 102 that extends from the main section 104. The tab section 102 of FIGS. 9-10 comprises a portion of the dog tail 114 to a tip 115 of the tail. The main section 104 of FIGS. 9-10 comprises a portion of the dog body 106 and a portion of the dog tail 114. In FIG. 9, front views of the face 108a, torso 110a, legs 112a, tail 114a, and ears 116a are depicted. In FIG. 10, back views of the back side 111b, legs 112b, tail 114b, and ears 116b are depicted. The legs 112 are at a first end 118 of the main section and a portion of the tail 114 extends from a second end 120 of the main section, which is opposite from the first end 118. In the embodiment of FIGS. 9-10, the main section 104 further comprises a background 124 around the dog body 106 in that the edges 125, 126, 127, and 128 of the main section 104 of the article frame the depiction of the dog body and portion of the tail. The overall shape of the main section may be any shape suitable for the application including but not limited to rectangular, square, circular, and oval. The background 124 may have any design including but not limited to solid colors and/or landscape or setting appropriate to the animal. In the embodiment of FIGS. 9-10, the tab section 102 is coextensive with the portion of the dog tail 114 to a tip 115 of the tail in that the edges of the article follow the edges of the depiction of the portion of the dog tail to its tip. Depth of the animal article may be analogous to that of FIGS. 2 and 5, or the depth may be varied to suit a particular application. The tab section 102 optionally comprises a hole 122 from the front surface to the back surface, which may be for receipt of a fastener for display and/or general use of the article.

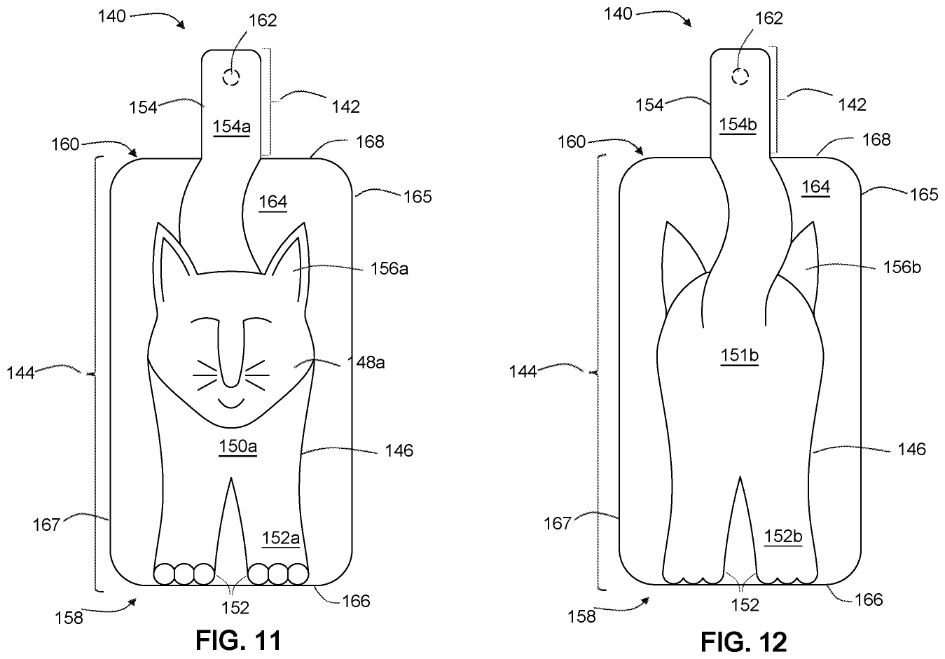

FIG. 11 is a front view of an animal article 140; and FIG. 12 is a back view of the animal article. The article of FIGS. 11-12 is in the form of a cat medallion. The animal article 140 comprises a main section 144, and a tab section 142 that extends from the main section 144. The tab section 142 of FIGS. 11-12 comprises a portion of the cat tail 154, but does not depict a tip of the tail. That is, the tail is blended into the tab section. The main section 144 of FIGS. 11-12 comprises a portion of the cat body 146 and a portion of the cat tail 154. In FIG. 11, front views of the face 148a, torso 150a, legs 152a, tail 154a, and ears 156a are depicted. In FIG. 12, back views of the back side 151b, legs 152b, tail 154b, and ears 156b are depicted. The legs 152 are at a first end 158 of the main section and a portion of the tail 154 extends from a second end 160 of the main section, which is opposite from the first end 158. In the embodiment of FIGS. 11-12, the main section 144 further comprises a background 164 around the cat body 146 in that the edges 165, 166, 167, and 168 of the main section 144 of the article frame the depiction of the cat body and portion of the tail. The overall shape of the main section may be any shape suitable for the application including but not limited to rectangular, square, circular, and oval. The background 164 may have any design including but not limited to solid colors and/or landscape or setting appropriate to the animal. In the embodiment of FIGS. 11-12, the tab section 142 is coextensive with the portion of the cat tail 154 in that the edges of the article follow the edges of the depiction of the portion of the cat tail. Depth of the animal article may be analogous to that of FIGS. 2 and 5, or the depth may be varied to suit a particular application. The tab section 142 optionally comprises a hole 162 from the front surface to the back surface, which may be for receipt of a fastener for display and/or general use of the article.

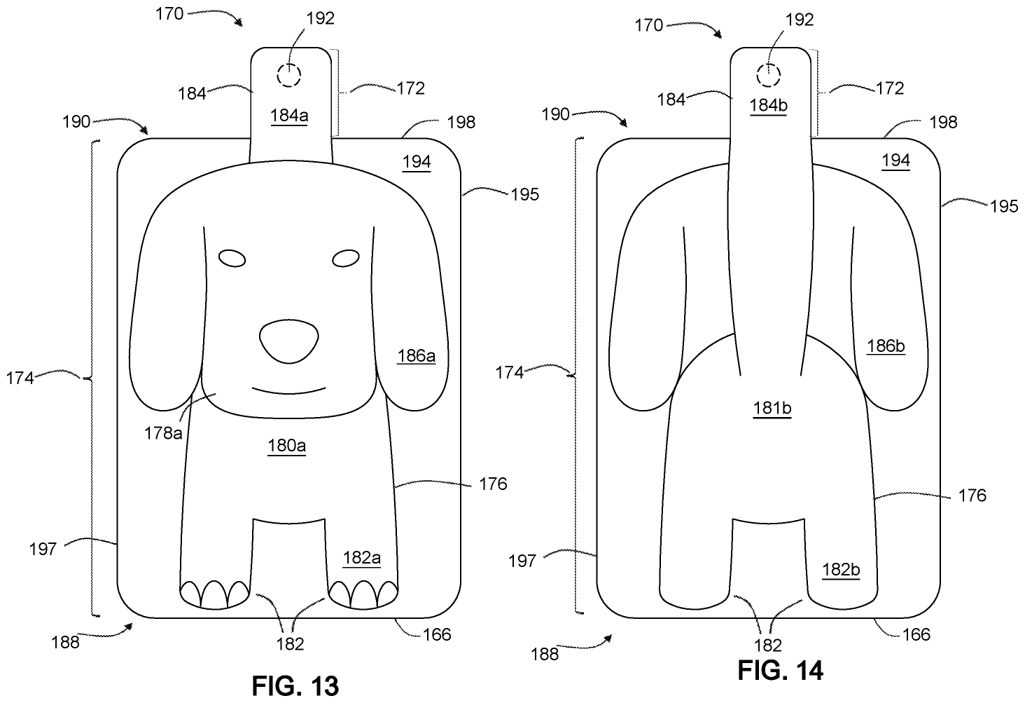

FIG. 13 is a front view of an animal article 170; and FIG. 14 is a back view of the animal article. The article of FIGS. 13-14 is in the form of a dog medallion. The animal article 170 comprises a main section 174, and a tab section 172 that extends from the main section 174. The tab section 172 of FIGS. 13-14 comprises a portion of the dog tail 184, but does not depict a tip of the tail. That is, the tail is blended into the tab section. The main section 174 of FIGS. 13-14 comprises a portion of the dog body 176 and a portion of the dog tail 184. In FIG. 13, front views of the face 178a, torso 180a, legs 182a, tail 184a, and ears 186a are depicted. In FIG. 13, back views of the back side 181b, legs 182b, tail 184b, and ears 186b are depicted. The legs 182 are at a first end 188 of the main section and a portion of the tail 184 extends from a second end 190 of the main section, which is opposite from the first end 188. In the embodiment of FIGS. 13-14, the main section 174 further comprises a background 194 around the dog body 176 in that the edges 195, 196, 197, and 198 of the main section 174 of the article frame the depiction of the dog body and portion of the tail. The overall shape of the main section may be any shape suitable for the application including but not limited to rectangular, square, circular, and oval. The background 194 may have any design including but not limited to solid colors and/or landscape or setting appropriate to the animal. In the embodiment of FIGS. 13-14, the tab section 172 is coextensive with the portion of the dog tail 184 in that the edges of the article follow the edges of the depiction of the portion of the dog tail. Depth of the animal article may be analogous to that of FIGS. 2 and 5, or the depth may be varied to suit a particular application. The tab section 172 optionally comprises a hole 192 from the front surface to the back surface, which may be for receipt of a fastener for display and/or general use of the article.

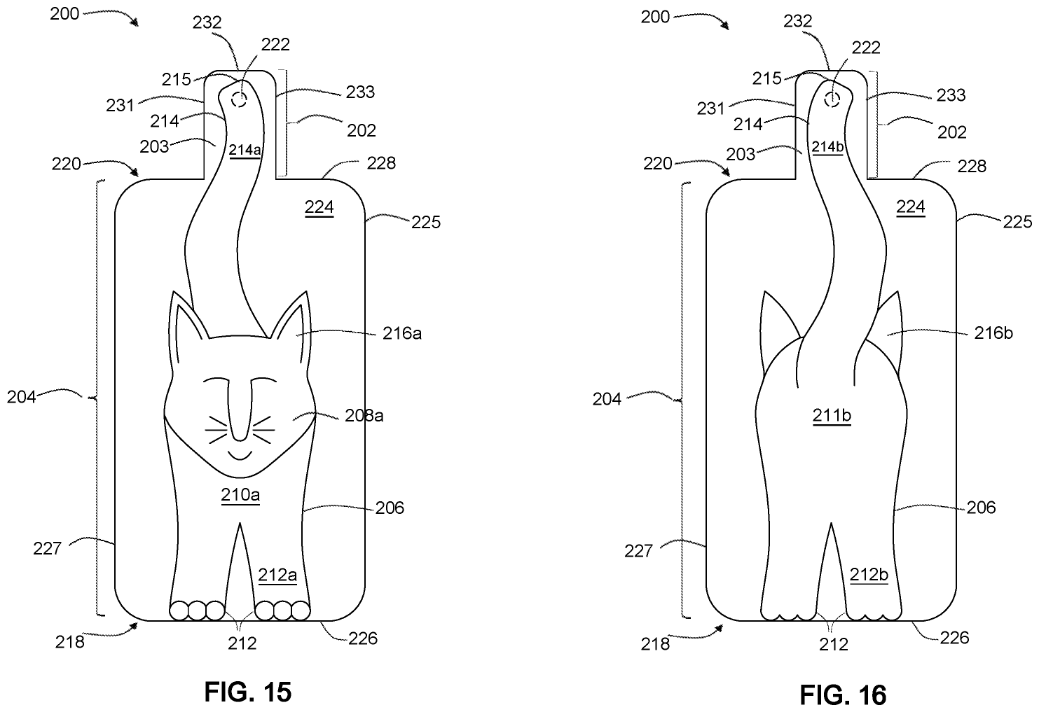

FIG. 15 is a front view of an animal article 200; and FIG. 16 is a back view of the animal article. The article of FIGS. 15-16 is in the form of a cat medallion. The animal article 200 comprises a main section 204, and a tab section 202 that extends from the main section 204. The tab section 202 of FIGS. 15-16 comprises a portion of the cat tail 214 to a tip 215 of the tail. The main section 204 of FIGS. 15-16 comprises a portion of the cat body 206 and a portion of the cat tail 214. In FIG. 15, front views of the face 208a, torso 210a, legs 212a, tail 214a, and ears 216a are depicted. In FIG. 16, back views of the back side 211b, legs 212b, tail 214b, and ears 216b are depicted. The legs 212 are at a first end 218 of the main section and a portion of the tail 214 extends from a second end 220 of the main section, which is opposite from the first end 218. In the embodiment of FIGS. 15-16, the main section 204 further comprises a background 224 around the cat body 206 in that the edges 225, 226, 227, and 228 of the main section 204 of the article frame the depiction of the cat body and portion of the tail. The overall shape of the main section may be any shape suitable for the application including but not limited to rectangular, square, circular, and oval. The background 224 may have any design including but not limited to solid colors and/or landscape or setting appropriate to the animal. In the embodiment of FIGS. 15-16, the tab section 202 further comprises a background 203 around the portion of the cat tail 214 including its tip 215 in that the edges 231, 232, and 233 of the tab section 202 frame the depiction of the portion of the cat tail including the tip. Depth of the animal article may be analogous to that of FIGS. 2 and 5, or the depth may be varied to suit a particular application. The tab section 202 optionally comprises a hole 222 from the front surface to the back surface, which may be for receipt of a fastener for display and/or general use of the article.

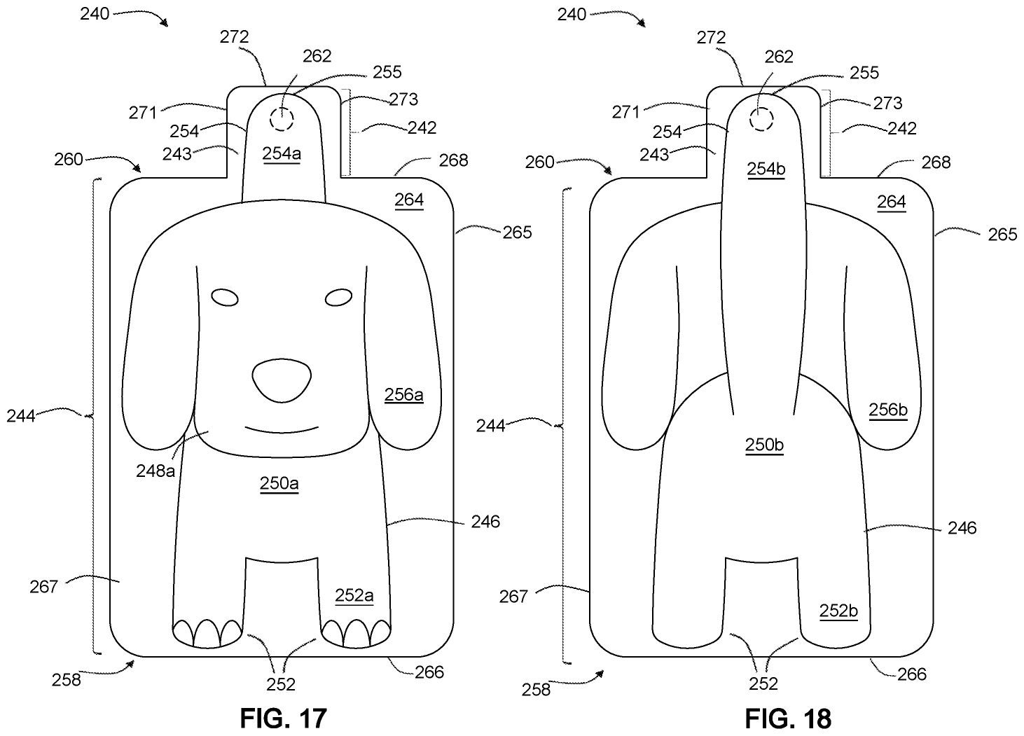

FIG. 17 is a front view of an animal article 240; and FIG. 18 is a back view of the animal article. The article of FIGS. 17-18 is in the form of a dog medallion. The animal article 240 comprises a main section 244, and a tab section 242 that extends from the main section 244. The tab section 242 of FIGS. 17-18 comprises a portion of the dog tail 254 to a tip 255 of the tail. The main section 244 of FIGS. 17-18 comprises a portion of the dog body 246 and a portion of the dog tail 254. In FIG. 17, front views of the face 248a, torso 250a, legs 252a, tail 254a, and ears 256a are depicted. In FIG. 18, back views of the back side 251b, legs 252b, tail 254b, and ears 256b are depicted. The legs 252 are at a first end 258 of the main section and a portion of the tail 254 extends from a second end 260 of the main section, which is opposite from the first end 258. In the embodiment of FIGS. 17-18, the main section 244 further comprises a background 264 around the dog body 246 in that the edges 265, 266, 267, and 268 of the main section 244 of the article frame the depiction of the cat body and portion of the tail. The overall shape of the main section may be any shape suitable for the application including but not limited to rectangular, square, circular, and oval. The background 264 may have any design including but not limited to solid colors and/or landscape or setting appropriate to the animal. In the embodiment of FIGS. 17-18, the tab section 242 further comprises a background 243 around the portion of the dog tail 254 including its tip 255 in that the edges 271, 272, and 273 of the tab section 242 frame the depiction of the portion of the dog tail including the tip. Depth of the animal article may be analogous to that of FIGS. 2 and 5, or the depth may be varied to suit a particular application. The tab section 242 optionally comprises a hole 262 from the front surface to the back surface, which may be for receipt of a fastener for display and/or general use of the article.

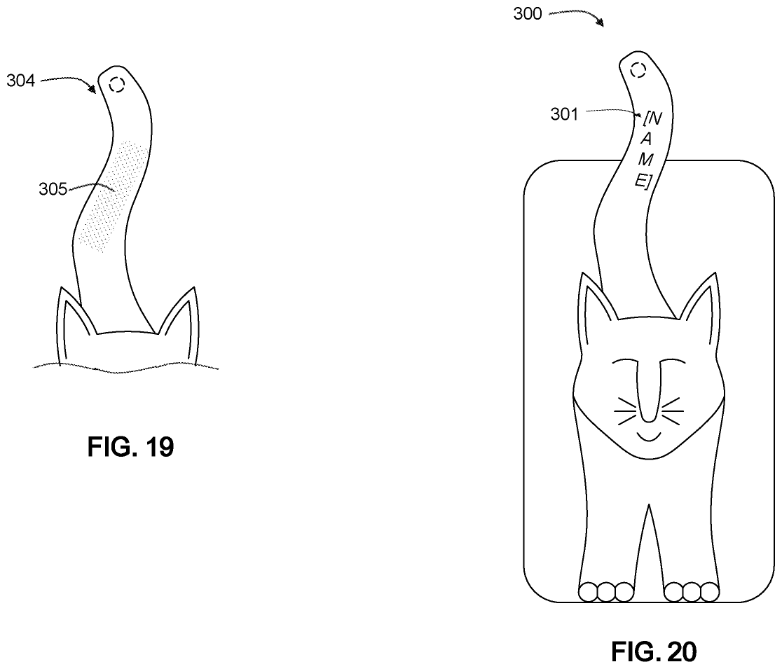

FIG. 19 depicts an exemplary tail 304 comprising one or more tactile features 305, including but not limited to fur, bumps, ridges, and the like. The tactile features may be present in all of the tail or portions of the tail. Tactile features may be included on any part of the article.

FIG. 20 is an exemplary article 300 including an area for receiving personalized information 301.

### Embodiments

The disclosure includes the following numbered embodiments:

1. An article depicting an animal with a tail, the article comprising: a main section that depicts a portion of a body of the animal; a tab section extending from the main section that depicts at least a portion of the tail of the animal.

2. The article of embodiment 1, wherein the body of the animal includes a face, a torso, a back side, legs, and ears, the legs being located at a first end of the main section, and the tail extending from a second end of the main section that is opposite from the first end.

3. The article of embodiment 1, wherein the portion of the body and the portion of the tail are in the same plane.

4. The article of embodiment 1, wherein the animal is a felidae, a canidae, an equidae, a suidae, a bovinae, a leporidae, a mephitidae, a mustelidae, a procyonidae, a rodentia, or a sciuridae.

5. The article of the preceding embodiment, wherein the animal is a cat, an ocelot, a dog, a horse, a zebra, a donkey, a skunk, a mouse, a rat, a rabbit, a hare, a squirrel, a chipmunk, a raccoon, a badger, a cow, a fox, or a pig.

6. The article of any preceding embodiment 1 further comprising a hole through the tab section.

7. The article of any preceding embodiment, which is effective as a toy or a medallion.

8. The article of the preceding embodiment, which is a medallion effective as a piece of jewelry, a key ring, or a luggage tag.

9. The article of embodiment 1, wherein the main section is coextensive with the portion of the body of the animal.

10. The article of embodiment 1, wherein the main section further comprises a background to the portion of the body of the animal.

11. The article of any embodiment 1 to 10, wherein the tab section is coextensive with the portion of the tail.

12. The article of the preceding embodiment, wherein the tab section is coextensive with the portion of the tail up to a tip of the tail.

13. The article of any embodiment 1 to 10, wherein a portion of the tab section comprises a background to the portion of the tail to a tip of the tail.

14. The article of any preceding embodiment, wherein a front surface of the main section depicts a face and front sides of a torso and front legs of the animal, and a back surface of the main section depicts a back of a head and back sides of the torso and back legs of the animal.

15. The article of any preceding embodiment formed from a polymer, a metal, wood, or composite material of any of the foregoing.

16. The article of any preceding embodiment, wherein the tab section is effective as a handhold.

17. The article of any preceding embodiment further comprising one or more tactile features.

18. The article of the preceding embodiment, wherein the tail further comprises the one or more tactile features.

19. The article of any preceding embodiment further comprising an area for receiving personalized information.

20. A portable article comprising: a main section that depicts a portion of a body of an animal, the body including a head, a torso, and legs, the legs being located at a first end of the main section; a tab section extending from the main section that depicts at least a portion of the tail of the animal, the tail extending from a second end of the main section that is opposite from the first end; wherein the portion of the body and the portion of the tail are in the same plane.

21. The portable article of embodiment 20 further comprising a hole through the tail section.

22. The portable article of embodiment 20 or 21, wherein front surfaces of the main section and the tab section depict front views of the body and tail, respectively, and back surfaces of the main section and tab section depict back views of the body and tail, respectively.

23. A method of reducing anxiety in a human suffering from one or more symptoms of anxiety, the method comprising: presenting a human with a portable article comprising: a main section that depicts a portion of a body of an animal, the body including a head, a torso, and legs, the legs being located at a first end of the main section, a tab section extending from the main section that depicts at least a portion of the tail of the animal, the tail extending from a second end of the main section that is opposite from the first end, wherein the portion of the body and the portion of the tail are in the same plane.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. An article depicting an animal with a tail, the article comprising:
a main section that depicts a portion of a body of the animal;
a tab section extending from the main section that depicts at least a portion of the tail of the animal.

2. The article of claim 1, wherein the body of the animal includes a face, a torso, a back side, legs, and ears, the legs being located at a first end of the main section, and the tail extending from a second end of the main section that is opposite from the first end.

3. The article of claim 1, wherein the portion of the body and the portion of the tail are in the same plane.

4. The article of claim 1, wherein the animal is a cat, an ocelot, a dog, a horse, a zebra, a donkey, a skunk, a mouse, a rat, a rabbit, a hare, a squirrel, a chipmunk, a raccoon, a badger, a cow, a fox, or a pig.

5. The article of any preceding claim 1 further comprising a hole through the tab section.

6. The article of claim 1, which is effective as a toy or a medallion.

7. The article of claim 1, which is a medallion effective as a piece of jewelry, a key ring, or a luggage tag.

8. The article of claim 1, wherein the main section is coextensive with the portion of the body of the animal.

9. The article of claim 1, wherein the main section further comprises a background to the portion of the body of the animal.

10. The article of claim 1, wherein the tab section is coextensive with the portion of the tail.

11. The article of claim 10, wherein the tab section is coextensive with the portion of the tail up to a tip of the tail.

12. The article of claim 1, wherein a portion of the tab section comprises a background to the portion of the tail to a tip of the tail.

13. The article of claim 1, wherein a front surface of the main section depicts a face and front sides of a torso and front legs of the animal, and a back surface of the main section depicts a back of a head and back sides of the torso and back legs of the animal.

14. The article of claim 1 formed from a polymer, a metal, wood, or composite material of any of the foregoing.

15. The article of claim 1, wherein the tab section is effective as a handhold.

16. The article of claim 1 further comprising an area for receiving personalized information.

17. A portable article comprising:
a main section that depicts a portion of a body of an animal, the body including a head, a torso, and legs, the legs being located at a first end of the main section;
a tab section extending from the main section that depicts at least a portion of the tail of the animal, the tail extending from a second end of the main section that is opposite from the first end;
wherein the portion of the body and the portion of the tail are in the same plane.

18. The portable article of claim 17 further comprising a hole through the tail section.

19. The portable article of claim 17, wherein front surfaces of the main section and the tab section depict front views of the body and tail, respectively, and back surfaces of the main section and tab section depict back views of the body and tail, respectively.

20. A method of reducing anxiety in a human suffering from one or more symptoms of anxiety, the method comprising:
presenting a human with a portable article comprising:
a main section that depicts a portion of a body of an animal, the body including a head, a torso, and legs, the legs being located at a first end of the main section,
a tab section extending from the main section that depicts at least a portion of the tail of the animal, the tail extending from a second end of the main section that is opposite from the first end,
wherein the portion of the body and the portion of the tail are in the same plane.
